(19) United States
(12) Patent Application Publication
(10) Pub. No.: US 2015/0035421 A1
(43) Pub. Date: Feb. 5, 2015

(54) DISMANTLE-ABLE COMPUTER CASING

(71) Applicant: WEI-TING HSIUNG, CHIAYI CITY (TW)

(72) Inventor: WEI-TING HSIUNG, CHIAYI CITY (TW)

(21) Appl. No.: 13/956,529

(22) Filed: Aug. 1, 2013

(51) Int. Cl. G06F 1/18

(52) U.S. Cl. CPC G06F 1/182
USPC 312/265.5

(57) ABSTRACT

A dismantle-able computer casing comprises a bottom unit planar board, a left unit planar board and a right unit planar board. The left and right edges of the bottom unit planar board each have a protruding plate protruding from and perpendicular to the bottom unit planar board. The left unit planar board is fixed to the protruding plate at the left edge of the bottom unit planar board by screws. The right unit planar board is fixed to the protruding plate at the right edge of the bottom unit planar board by screws.

### BACKGROUND OF THE INVENTION

1. Field of the Invention

The present disclosure relates to a computer casing; in particular, to a computer casing whose parts can be disassembled into unit planar boards.

2. Description of Related Art

Conventional computer casings, in particular industrial computer casings, are mainly U-shaped bases for housing motherboards and hard drives. However, a U-shaped base increases the storage and transportation space, and the associated packaging material and transportation cost are also raised.

Therefore, a structural design that improves upon the abovementioned deficiencies is an important issue for professionals in the industry. Hence, the present inventor believes the above mentioned disadvantages can be overcome, and through devoted research combined with application of disengagement, finally proposes the present disclosure which has a reasonable design and effectively reduces the storage space during transportation, is easy to assemble and disassemble, and provides reasonable stability and carrying ability.

### SUMMARY OF THE INVENTION

The object of the present disclosure is to provide a dismantle-able computer casing which can be disassembled into unit planar boards, conducive to reduction of packaging material, transportation cost and storage space. Moreover, the structure is easily disassembled and assembled and provides a reasonable stability and carrying ability.

In order to achieve the aforementioned objects, a dismantle-able computer casing of the present disclosure includes a bottom unit planar board, a left unit planar board and a right unit planar board. The bottom unit planar board has a protruding plate protruding from and perpendicular to each of the left and right edges of the bottom unit planar board. The left unit planar board is screwed onto the left protruding plate of the bottom unit planar board. Analogously, the right unit planar board is screwed onto the right protruding plate of the bottom unit planar board.

In light of the above, the unit planar boards of the dismantle-able computer casing of the present disclosure reduce storage space, packaging material, and transportation cost. Additionally, the dismantle-able computer casing of the present disclosure has a protruding plate protruding from and perpendicular to each of the left and right edges of the bottom unit planar board, such that the left unit planar board and the right unit planar board can be fixed to the protruding plates of the bottom unit planar board by screws to increase the strength and durability of the assembled computer casing.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a perspective exploded view of a dismantle-able computer casing according to the present disclosure;

FIG. 2 shows a perspective view of an assembled dismantle-able computer casing according to the present disclosure;

FIG. 3 shows an enlarged view of section A of FIG. 2;

FIG. 4 shows an enlarged partial exploded view of a dismantle-able computer casing according to the present disclosure;

FIG. 5 shows a perspective view of an assembled dismantle-able computer casing according a second embodiment of the present disclosure;

FIG. 6 shows an enlarged view of section B of FIG. 5;

FIG. 7 shows an enlarged partial exploded view of a dismantle-able computer casing according to a second embodiment of the present disclosure;

FIG. 8 shows a perspective view of an assembled dismantle-able computer casing according to a third embodiment of the present disclosure;

FIG. 9 shows an enlarged partial exploded view of a dismantle-able computer casing according to a third embodiment of the present disclosure;

FIG. 10 shows an enlarged partial exploded view of a dismantle-able computer casing according to a third embodiment of the present disclosure from another perspective;

FIG. 11 shows a perspective view of an assembled dismantle-able computer casing according to a fourth embodiment of the present disclosure;

FIG. 12 shows an enlarged partial exploded view of a dismantle-able computer casing according to a fourth embodiment of the present disclosure;

FIG. 13 shows an enlarged partial exploded view of a dismantle-able computer casing according to a fourth embodiment of the present disclosure from another perspective;

FIG. 14 shows a cross-sectional view along line C-C of FIG. 13;

FIG. 15 shows a perspective view of an assembled dismantle-able computer casing according to a fifth embodiment of the present disclosure;

FIG. 16 shows an enlarged partial exploded view of a dismantle-able computer casing according to a fifth embodiment of the present disclosure;

FIG. 17 shows an enlarged partial exploded view of a dismantle-able computer casing according to a fifth embodiment of the present disclosure from another perspective; and

FIG. 18 shows a cross-sectional view along line D-D of FIG. 17.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in but not limited by the subsequent descriptions and appended drawings.

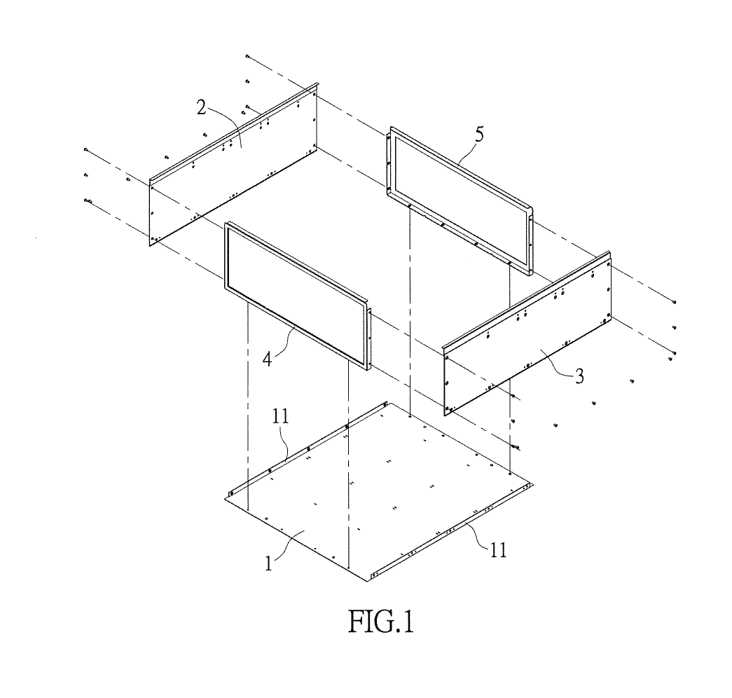

FIG. 1 shows an embodiment of the dismantle-able computer casing according to the present disclosure. The dismantle-able computer casing of the present disclosure can be a casing for any type of computer, preferably an industrial computer for carrying multiple hard drives. The dismantle-able computer casing of the present embodiment basically includes a bottom unit planar board 1, a left unit planar board 2, and a right unit planar board 3. The dismantle-able computer casing of the present embodiment can further include a front unit planar board 4 and a rear unit planar board 5. In other words, each of the boards of the dismantle-able computer casing of an embodiment of the present disclosure is an independent unit planar structure.

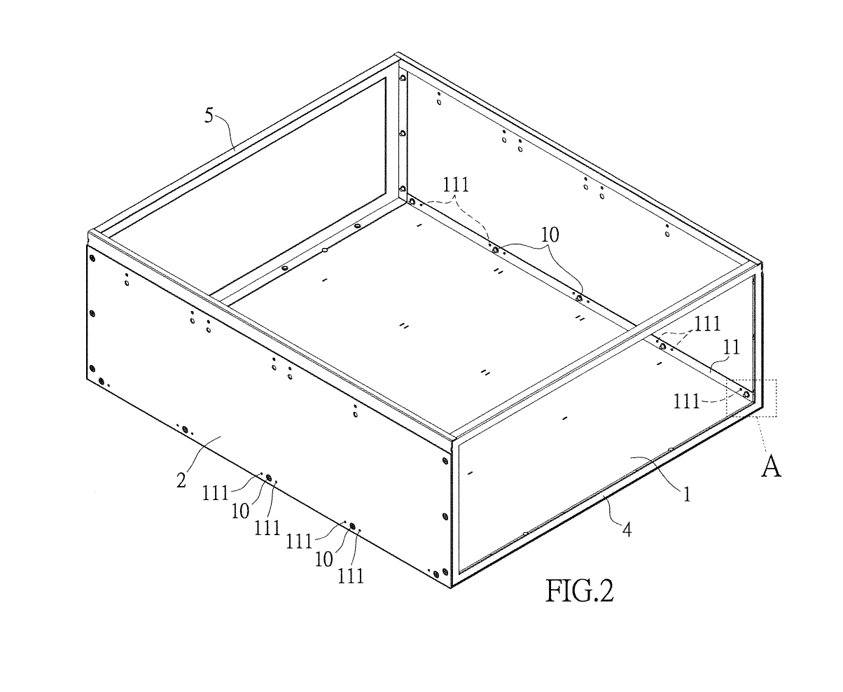

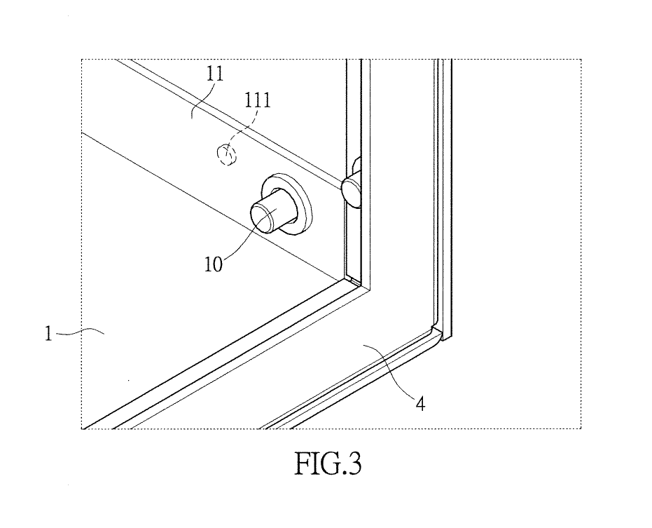

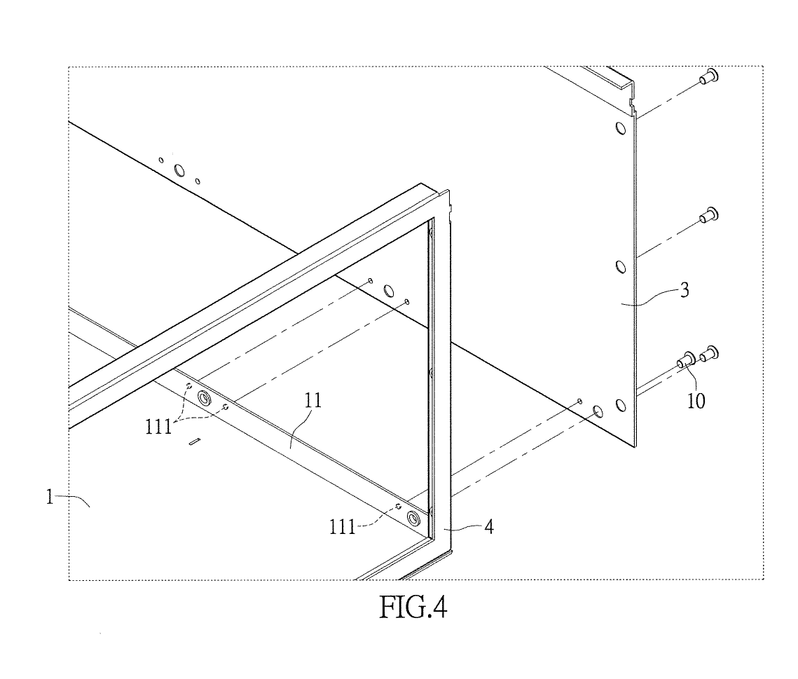

Please refer to FIG. 2 to FIG. 4 in conjunction with FIG. 1. The bottom unit planar board 1 is made of metal, e.g. iron. The left unit planar board 2 and the right unit planar board 3 can also be made of metal. Each of the left and right edges of the bottom unit planar board 1 has a protruding plate 11 protruding from and perpendicular to the bottom unit planar board 11. The protruding plates 11 are preferably formed by bending the left and right edges of the bottom unit planar board 1. The left unit planar board 2 is screwed to the protruding plate 11 on the left edge of the bottom unit planar board 1 by screws 10. Similarly, the right unit planar board 3 is screwed to the protruding plate 11 on the right edge of the bottom unit planar board 1 by screws 10. Additionally, the protruding plates 11 each have a plurality of fixing columns 111 respectively penetrating into the left unit planar board 2 and the right unit planar board 3, in order to fix the left unit planar board 2 and the right unit planar board 3 on the protruding plates 11 and act in concert with the screws 10 such that the left unit planar board 2 and the right unit planar board 3 are secured for better strength and bearing capacity.

Additionally, the front unit planar board 4 is fixed to the front edge of the bottom unit planar board 1 by screws 10 and is positioned between the left unit planar board 2 and the right unit planar board 3. The rear unit planar board 5 is fixed to the rear edge of the bottom unit planar board 1 by screws 10 and is positioned between the left unit planar board 2 and the right unit planar board 3.

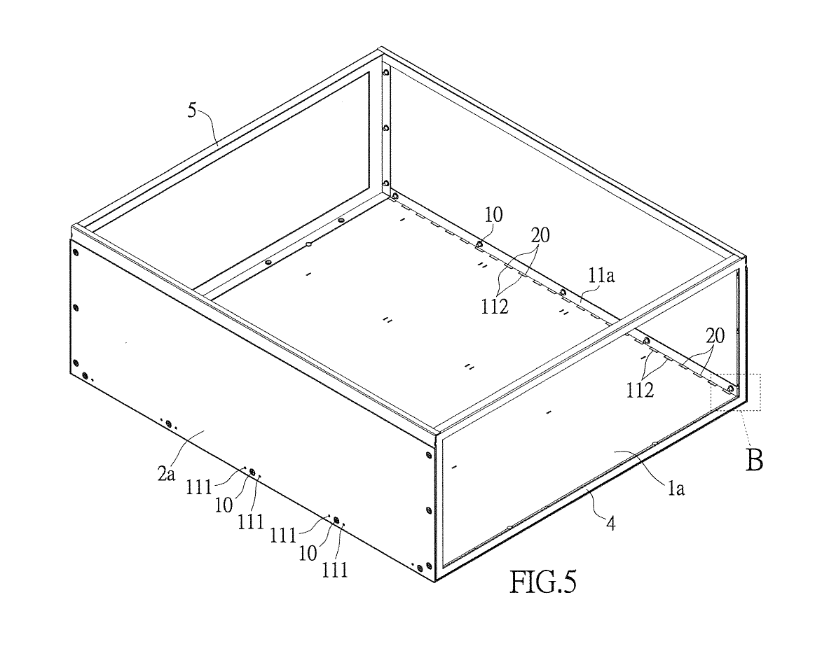

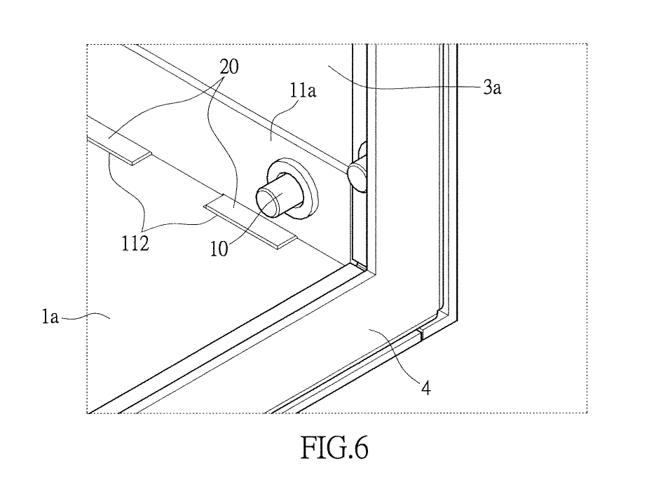

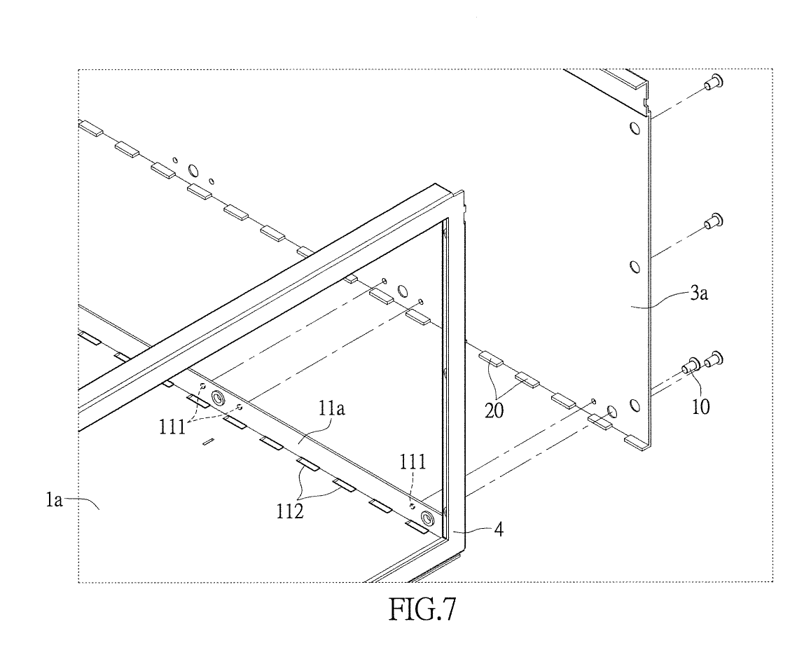

FIG. 5 to FIG. 7 show a second embodiment of the dismantle-able computer casing of the present disclosure. The difference between the present embodiment and the first embodiment is that a plurality of engagement grooves 112 is arranged at intervals at the bending portion between the bottom unit planar board 1a and the protruding plates 11a. The left unit planar board 2a and the right unit planar board 3a each have a plurality engagement protrusions 20 corresponding to the engagement grooves 112. The engagement protrusions 20 act in concert with the fixing columns 111 and the screws 10 to provide a more stable fixture. The shape of the engagement grooves 112 of the present embodiment is rectangular, but it can also be semi-circular, gourd-shaped, etc. and is not limited thereto.

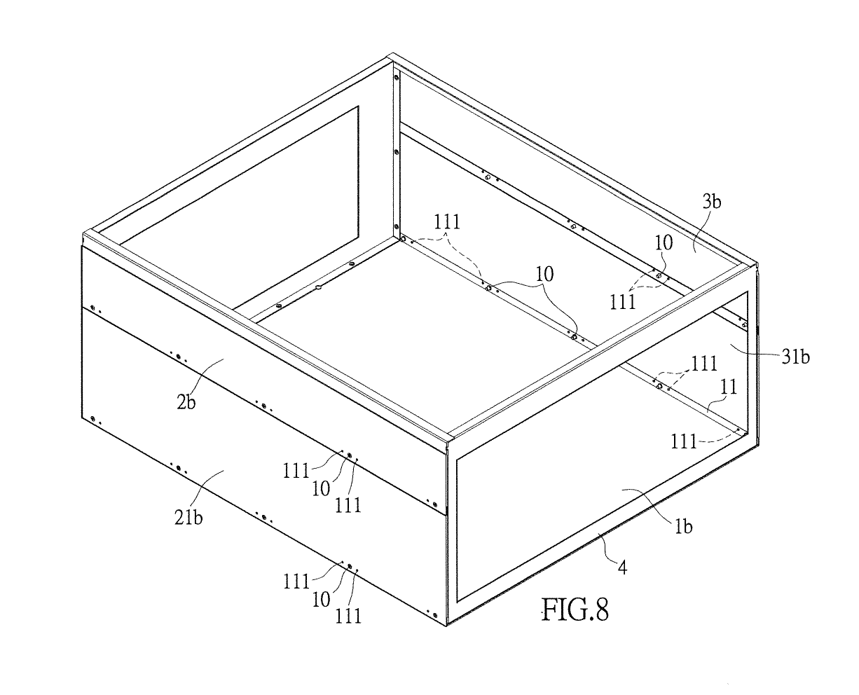

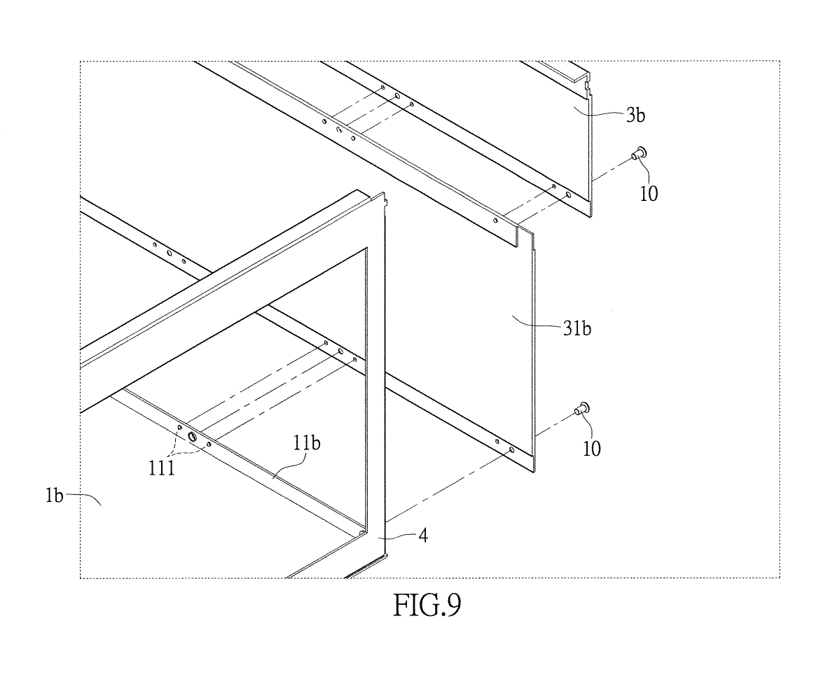

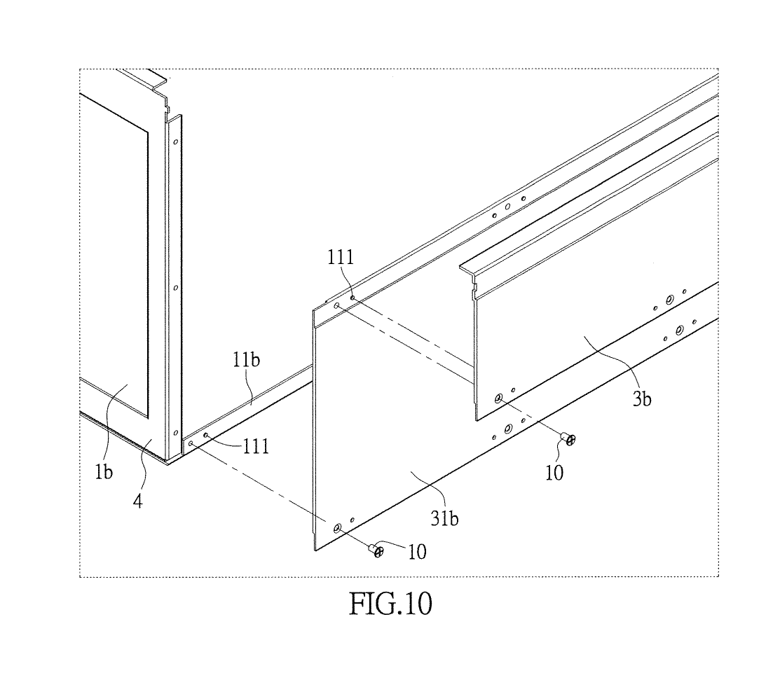

FIG. 8 to FIG. 10 show a third embodiment of the dismantle-able computer casing of the present disclosure. The difference between the present embodiment and the first embodiment is that, the left unit planar board 2b and the right unit planar board 3b are made by aluminum extrusion and each have a standard height of 2U˜4U (1U=44.45 mm). The dismantle-able computer casing can attain a standard height of 2U˜4U when the left unit planar board 2b and the right unit planar board 3b are fixed to the protruding plates 11b of the bottom unit planar board 1b by screws. Additionally in the present embodiment, the left unit planar board 2b further includes a left extension board 21b and the right unit planar board 3b further includes an analogous right extension board 31b. The height of the left extension board 21b and the right extension board 31b is 3U˜4U. The left extension board 21b is connected to the left unit planar board 2b and fixed thereto by screws 10 to form a stable unit planar structure which is in turn fixed to the protruding plate 11b of the bottom unit planar board 1b by screws 10. Similarly, the right extension board 31b is connected to the right unit planar board 3b and fixed thereto by screws 10 to form a stable unit planar structure, and is fixed to the protruding plate 11b of the bottom unit planar board 1b by screws 10. By this configuration, the height of the dismantle-able computer casing can be higher than 5U depending on design needs.

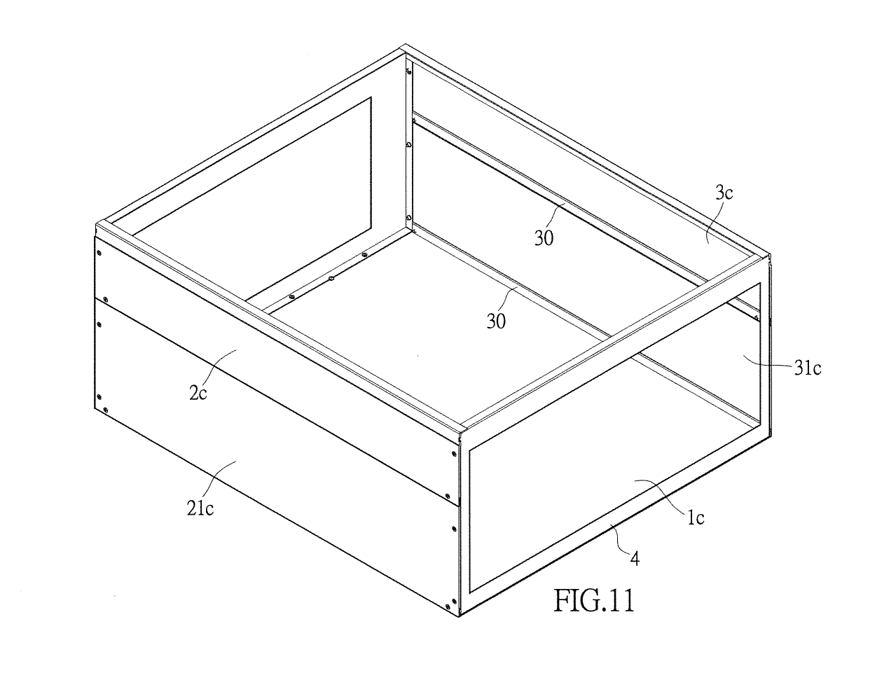

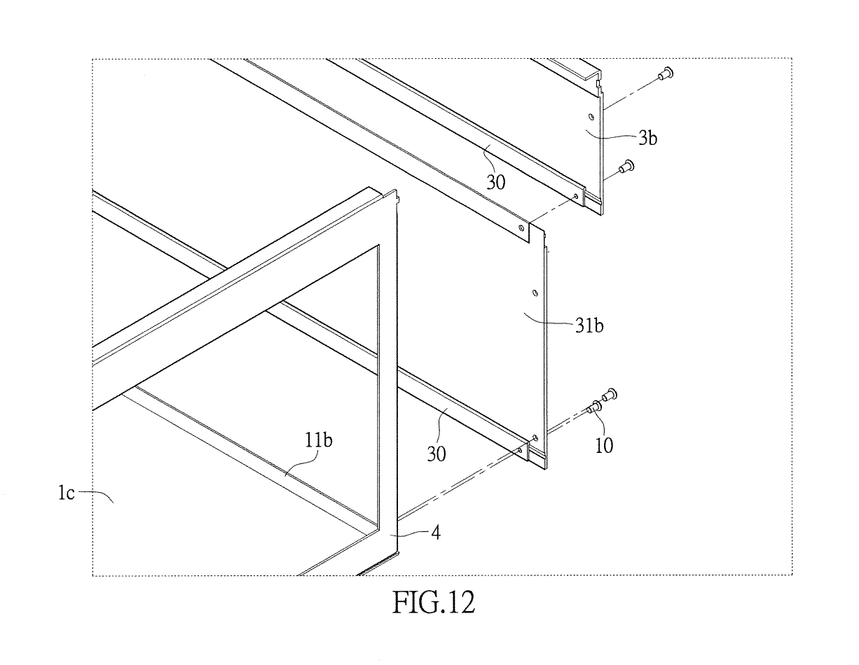

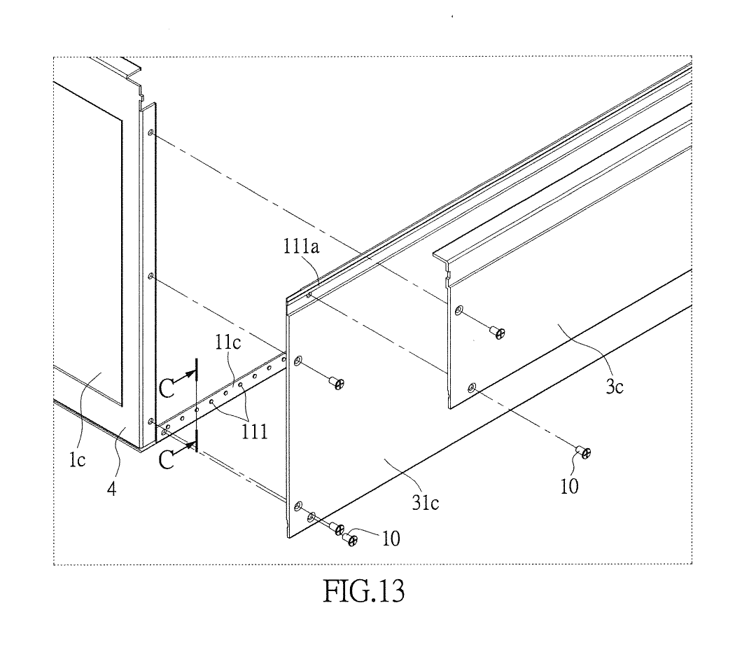

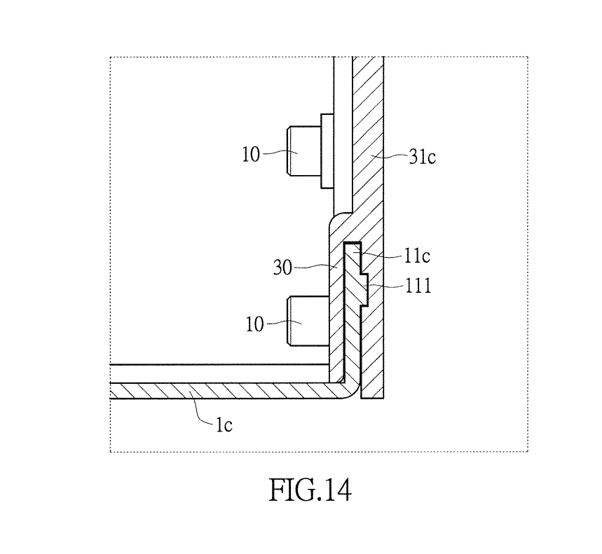

FIG. 11 to FIG. 14 show the fourth embodiment of the dismantle-able computer casing of the present disclosure. It must be noted that the left unit planar board 2c and the left extension board 21c are respectively symmetrical with the right unit planar board 3c and the right extension board 31c. Therefore, the following descriptions detail the right unit planar board 3c and the right extension board 31c as an example for the left counterparts. The difference between the present embodiment and the third embodiment is that a sliding groove 30 is formed at the connection between the right unit planar board 3c and the right extension board 31c (refer to FIG. 14). In different embodiments, the surface of the sliding groove 30 can be, but is not limited to, U-shaped, V-shaped, dovetail-shaped, etc. Proximal to the top edge of the right extension board 31c, one side of the right extension board 31c has a fixing strip 111a slidably engaged with the inner wall of the sliding groove 30. The right unit planar board 3c and the right extension board 31c are fixed by screws 10 to form a stable unit planar structure. Additionally, the bottom edge of the right extension board 31c has a sliding groove 30 (as shown in FIG. 14). One side of the protruding plate 11c of the bottom unit planar board 1c has a plurality of fixing columns 111 slidably engaged with the inner wall of the sliding groove 30. The bottom edge of the right extension board 31c and the protruding plate 11c of the bottom unit planar board 1c are fixed to each other in order to alter the height of the dismantle-able computer casing and increase the strength and bearing capacity of the same. It can be understood that the position of the fixing strip 111a can be switched with the position of the fixing columns 111. Namely, one side of the right extension board 31c can have the fixing columns 111, and one side of the protruding plate 11c can have the fixing strip 111a, to respectively slidably engage with the sliding grooves 30.

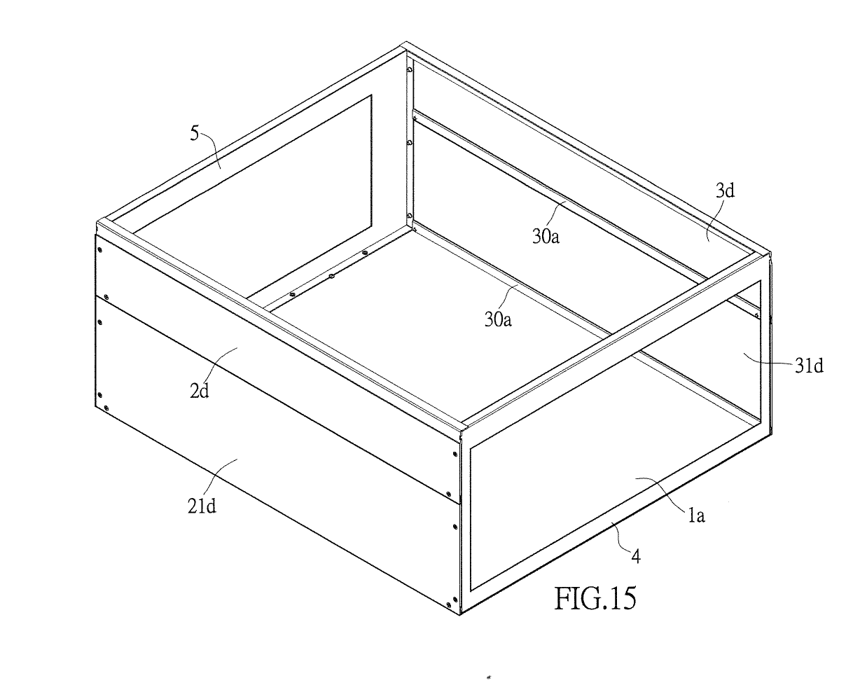

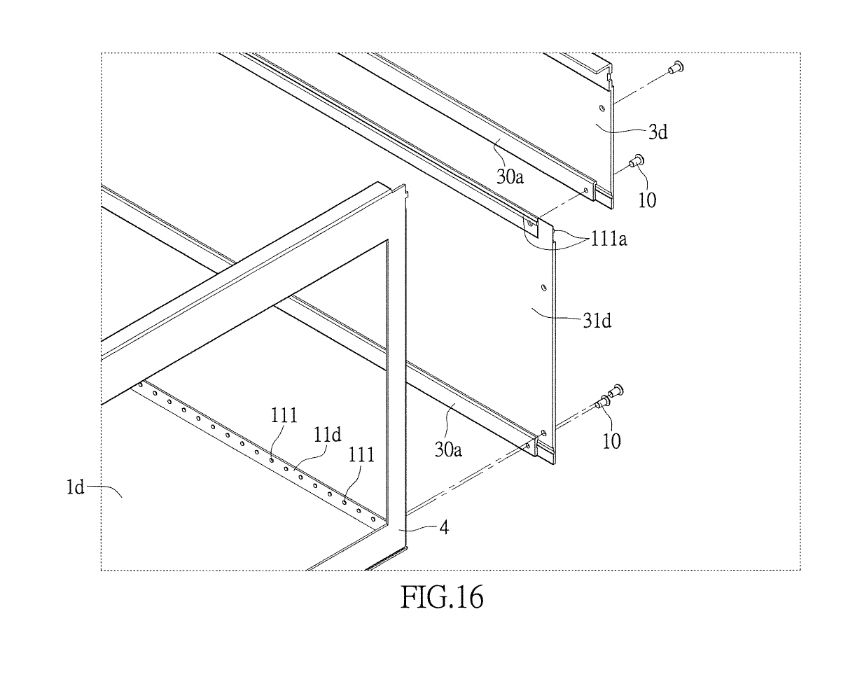

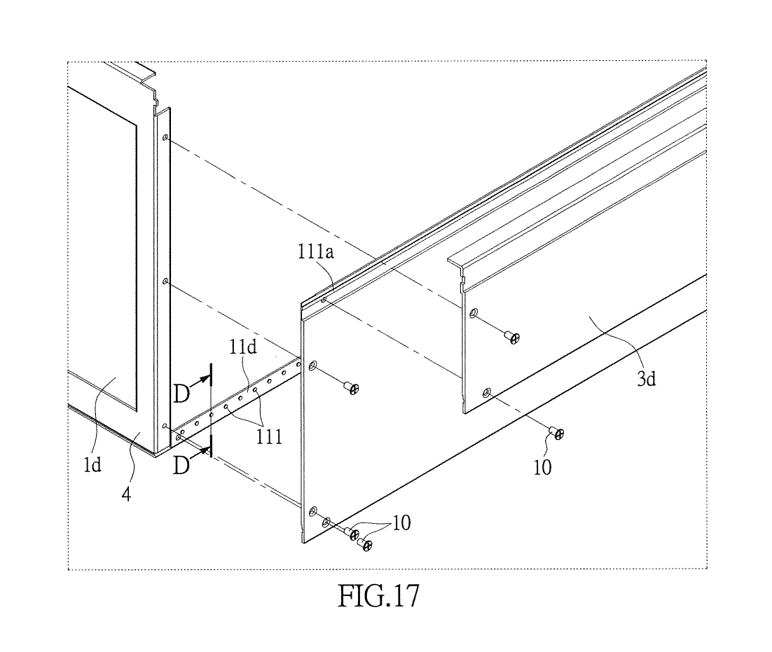

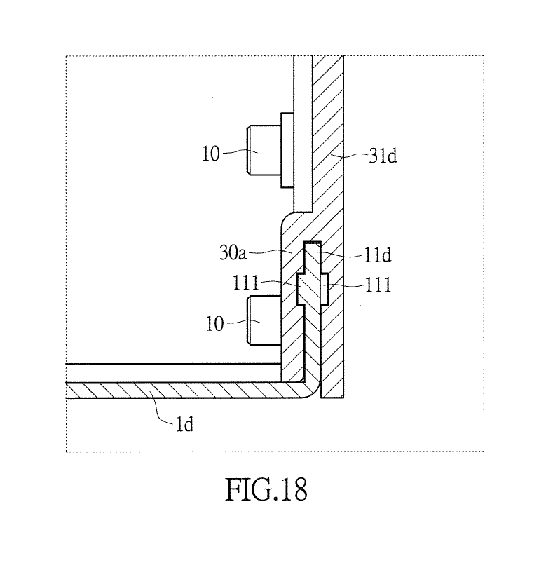

FIG. 15 to FIG. 18 show the fifth embodiment of the dismantle-able computer casing of the present disclosure. Likewise, it must be noted that the left unit planar board 2d and the left extension board 21d are respectively symmetrical with the right unit planar board 3d and the right extension board 31d. Therefore the following descriptions detail the right unit planar board 3d and the right extension board 31d as an example for the left counterparts. The difference between the present embodiment and the fourth embodiment is that proximal to the top edge of the right extension board 31d, both sides of the right extension board 31d each have a fixing strip 111a slidably engaged with the inner wall of the sliding groove 30a. Namely, each of the two sides of the right extension board 31d has a fixing strip 111a. Additionally, the two sides of the protruding plate 11d of the bottom unit planar board 1d each have fixing columns 111 for slidable engagement with the sliding groove 30a. In other words, having fixing strips 111a on both sides of the right extension board 31c and fixing columns 111 on both sides of the protruding plate 11c strengthens the engagement with the slidable groove 30a, and increases the strength and the bearing capacity of the dismantle-able computer casing after assembly. It can be understood that the position of the fixing strip 111a can be switched with the position of the fixing columns 111. Namely, both sides of the right extension board 31d can have the fixing columns 111, and one side of the protruding plate 11d can have the fixing strip 111a, to respectively and slidably engage with the sliding grooves 30a.

In summary, the design of the independent unit planar structures of the dismantle-able computer casing according to the present disclosure can effectively reduce storage or transportation space, and save packaging material, transportation cost and storage space. Additionally, the bottom unit planar board of the dismantle-able computer casing of the present disclosure has a protruding plate at its left and right edge, protruding from and perpendicular to the bottom unit planar board such that the left unit planar board and the right unit planar board can be fixed to the protruding plates by screws for increasing the strength and bearing capacity after assembly. Moreover, the dismantle-able computer casing of the present disclosure can utilize left and right extension boards to alter the height according to need. Additionally, two sides of the left and right unit planar boards each have a fixing strip slidably engaged with the sliding groove, and two sides of the protruding plate each have fixing columns slidably engaged with the sliding groove. In concert with fixing by screws, the strength and the bearing capacity is significantly increased after assembly for carrying more and heavier hard drives.

The descriptions illustrated supra set forth simply the preferred embodiments of the present disclosure; however, the characteristics of the present disclosure are by no means restricted thereto. All changes, alternations, or modifications conveniently considered by those skilled in the art are deemed to be encompassed within the scope of the present disclosure delineated by the following claims.

What is claimed is:

1. A dismantle-able computer casing, comprising:
a bottom unit planar board, the left and right edges of which each have a protruding plate protruding from and perpendicular to the bottom unit planar board;
a left unit planar board, fixed to the protruding plate at the left edge of the bottom unit planar board by screws; and
a right unit planar board, symmetrical to the left unit planar board and fixed to the protruding plate at the right edge of the bottom unit planar board by screws.

2. The dismantle-able computer casing according to claim 1, wherein the protruding plates each have a plurality of fixing columns, and the fixing columns respectively penetrate the left unit planar board and the right unit planar board for fixing the left unit planar board and the right unit planar board to the protruding plates.

3. The dismantle-able computer casing according to claim 1, wherein bending portions between the bottom unit planar board and the protruding plates each have a plurality of engagement grooves arranged at intervals, the left unit planar board and the right unit planar board each have a plurality of engagement protrusions corresponding to the engagement grooves, and the engagement protrusions respectively engage with the engagement grooves.

4. The dismantle-able computer casing according to claim 1 further comprising:
a front unit planar board and a rear unit planar board, wherein the front unit planar board is fixed to the front edge of the bottom unit planar board by screws and is arranged between the left unit planar board and the right unit planar board, and the rear unit planar board is fixed to the rear edge of the bottom unit planar board by screws and is positioned between the left unit planar board and the right unit planar board.

5. The dismantle-able computer casing according to claim 1, wherein the left unit planar board further comprises a left extension board, the top edge of the left extension board is connected and fixed to the left unit planar board, the bottom edge of the left extension board is fixed to the protruding plate at the left edge of the bottom unit planar board, the right unit planar board further comprises a right extension board symmetrical to the left extension board, the top edge of the right extension board is connected and fixed to the right unit planar board, and the bottom edge of the right extension board is fixed to the protruding plate at the right edge of the bottom unit planar board.

6. The dismantle-able computer casing according to claim 5, wherein the left unit planar board has a sliding groove at the connection portion with the left extension board, and one side of the left extension board proximal to the top edge of the left extension board has a fixing strip slidably engaged with the sliding groove.

7. The dismantle-able computer casing according to claim 5, wherein the left unit planar board has a sliding groove at the connection portion with the left extension board, and the two sides of the left extension board each have, proximal to the top edge of the left extension board, a fixing strip slidably engaged with the sliding groove.

8. The dismantle-able computer casing according to claim 5, wherein the bottom edge of the left extension board has a sliding groove, and one side of the protruding plate at the left edge of the bottom unit planar board has a plurality fixing of columns slidably engaged with the sliding groove.

9. The dismantle-able computer casing according to claim 5, wherein the bottom edge of the left extension board has a sliding groove, and the two sides of the protruding plate at the left end of the bottom unit planar board each have a plurality of fixing columns slidably engaged with the sliding groove.

10. The dismantle-able computer casing according to claim 5, wherein the right unit planar board has a sliding groove at the connection portion with the right extension board, and one side of the right extension board proximal to the top edge of the right extension board has a fixing strip slidably engaged with the sliding groove.

11. The dismantle-able computer casing according to claim 5, wherein the right unit planar board has a sliding groove at the connection portion with the right extension board, and the two sides of the right extension board each have, proximal to the top edge of the right extension board, a fixing strip slidably engaged with the sliding groove.

12. The dismantle-able computer casing according to claim 5, wherein the bottom edge of the right extension board has a sliding groove, and one side of the protruding plate at the right edge of the bottom unit planar board has a plurality fixing of columns slidably engaged with the sliding groove.

13. The dismantle-able computer casing according to claim 5, wherein the bottom edge of the right extension board has a sliding groove, and the two sides of the protruding plate at the right edge of the bottom unit planar board each have a plurality of fixing columns slidably engaged with the sliding groove.
